(19) United States
(12) Patent Application Publication
(10) Pub. No.: US 2008/0006573 A1
(43) Pub. Date: Jan. 10, 2008

(54) Exchangeable filter

(75) Inventors: Michael Wolf, Neunkirchen (DE); Jukka Schaerlund, Offenbach (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel, Ludwigsburg (DE)

(21) Appl. No.: 11/822,559

(22) Filed: Jul. 6, 2007

(30) Foreign Application Priority Data
Jul. 6, 2006 (DE) 20 2006 010 561.1

(51) Int. Cl. B01D 35/28

(52) U.S. Cl. 210/450; 210/445; 210/455

(57) ABSTRACT

An exchangeable filter (10), e.g. for filtering lubricating oil in internal combustion engines, having a housing (11) including a vessel (12), a lid (13) and a seal (25). A filter element (21) is situated inside the housing (11) in such a way that an oil inlet (18) is sealingly separated from an oil outlet (19). The lid (13) has a seal holder (15), in which a groove (27) for receiving the seal (25) is arranged. The seal (25) preferably has a beveled area (26), which projects at least partially beyond the seal holder (15). As a result of this beveled area (26), only small mounting forces are required to mount the exchangeable filter (10).

### BACKGROUND OF THE INVENTION

The present invention relates to a exchangeable filter for fluids, in particular for the lubricating oil of an internal combustion engine.

Exchangeable filters are known which comprise a filter element situated in a housing. The filter element is used, for example, for separating contaminants from lubricant oil. The housing includes a lid and a vessel, which is connected by a crimped connection to the lid. An oil inlet and an oil outlet are situated in the lid, through which the oil to be filtered may flow into or out of the exchangeable filter. Furthermore, a seal is situated on the lid, by which the exchangeable filter may be attached to a flange in a liquid tight manner. The seals are generally pre-finished rectangular seals, which are mounted in a groove in the lid. When the exchangeable filter is mounted, the seal is compressed between the lid and the flange in order to produce a sealing effect. Because the seal projects beyond the lid, the seal presses against the flange before the exchangeable filter has been screwed onto the flange with sufficient torque. In order to tighten the exchangeable filter with sufficient torque, large shear forces arise on the seal, which may result in damage to the seal. Furthermore, the problem arises that in the event of extremely large tightening torques, ruptures may occur in the crimped joint area.

### SUMMARY OF THE INVENTION

An object of the present invention is to provide an improved exchangeable filter for a liquid.

Another object is to provide an exchangeable filter which is simple to handle and avoids damage to the seal or mounting flange upon installation of the filter.

These and other objects are achieved in accordance with the present invention by providing a n exchangeable filter comprising a housing including a vessel, a lid and a seal, the lid having at least one fluid inlet, at least one fluid outlet, and a groove having a groove cross-section for receiving the seal; and a filter element sealingly situated in the housing such that the at least one inlet is separated from the at least one outlet; wherein the seal has a seal cross-section which is smaller than or equal to the groove cross-section.

The exchangeable filter according to the present invention is used for filtering liquids, in particular lubricant oil in internal combustion engines. The exchangeable filter comprises a housing including a vessel, a lid, and a seal. A filter element for filtering the lubricant oil is situated in the housing. The lid has a fluid inlet and a fluid outlet, the fluid inlet being separated by the filter element, which forms a seal, from the fluid outlet. To receive the seal, the lid has a groove having a groove cross-section, the groove being constructed as a seal holder. The lid may comprise a cover plate in which the inlet and outlet are integrated. The seal holder may be constructed in one piece with the cover plate or be constructed as a separate component. In the event the seal holder is constructed as a separate element, the seal holder is connected to the cover plate and/or the vessel. The seal has a seal cross-section, which is divided into an area enclosed by the groove and an area projecting beyond the groove. The entire seal cross-section is less than or equal to the groove cross-section, so that when an appropriate force acts on the seal, the entire seal cross-section is compressible into the groove. When the exchangeable filter is mounted, the area of the seal projecting beyond the groove may thus be compressed completely into the groove, because of which the seal presses against the adjoining component to form a seal due to its intrinsic tension, but is not compressed too strongly. Furthermore, the lid and/or the seal holder presses against the adjoining component, because of which reinforcement of the system is achieved and rupturing in the crimped joint between the lid and the vessel is prevented.

In one specific embodiment of the seal, the area projecting beyond the groove has a bevel, due to which the contact surface between the seal and an adjoining component, particularly a flange, is less than the area of the seal in the groove. As a result, the friction between the exchangeable filter and the adjoining component upon mounting is reduced.

According to a further embodiment of the present invention, the bevel corresponds to a trapezoid in cross-section. Due to the trapezoidal shape, the seal can be compressed symmetrically during mounting so that uniform contact of the seal is produced and thus better force distribution is achieved.

According to a further design, the seal has an internal diameter in the unmounted state of the exchangeable filter, which is greater than the internal diameter of the groove of the seal holder. Consequently, an internal intermediate volume is formed between the seal and the inner diameter of the groove, which is at least partially filled up during mounting of the exchangeable filter by the seal material which projects beyond the groove in the unmounted state. As a result, the mounting forces required for tightening the exchangeable filter may be reduced.

In one advantageous construction of the present invention, the external diameter of the seal is less than the external diameter of the groove of the seal holder. Therefore, an external intermediate volume forms, analogously to the internal intermediate volume described above, into which the seal may expand. If desired, a filter may be constructed provided with both internal and external intermediate volumes, so that the seal may expand in both directions.

In a further design of the seal, the seal has one or more hollow or recessed cross-sections. The hollow cross-section may be configured in any desired manner. A hollow cross-section may be completely enclosed by the seal. In this embodiment, the hollow cross-section is constructed as a bubble. In other designs, the a recessed cross-section may directly adjoin the groove wall or the groove base. In other designs, the recessed cross-section directly adjoins the groove base. In this case, the recessed cross-section may, for example, be U-shaped or S-shaped. As a result of the hollow or recessed cross section, the seal may be compressed in such a way that the seal is pressed completely into the groove cross-section, with the seal being exactly positioned and fixed in the groove.

### BRIEF DESCRIPTION OF THE DRAWINGS

The invention will be described in further detail hereinafter with reference to illustrative preferred embodiments shown in the accompanying drawing figures, in which:

FIG. 1 is a sectional detail view of an exchangeable filter according to the present invention;

FIG. 2 is a sectional view of a further seal design according to the invention;

FIG. 3 is a detail view of an exchangeable filter according to the invention in the mounted state;

FIG. 4a is a sectional view of a further design of the seal area;

FIG. 4b is a depiction of the seal area of FIG. 4a when the filter is in the mounted state;

FIG. 5a is a sectional view of yet another seal area design, and

FIG. 5b is a depiction of the seal area of FIG. 5a when the filter is in the mounted state.

### DETAILED DESCRIPTION OF PREFERRED EMBODIMENTS

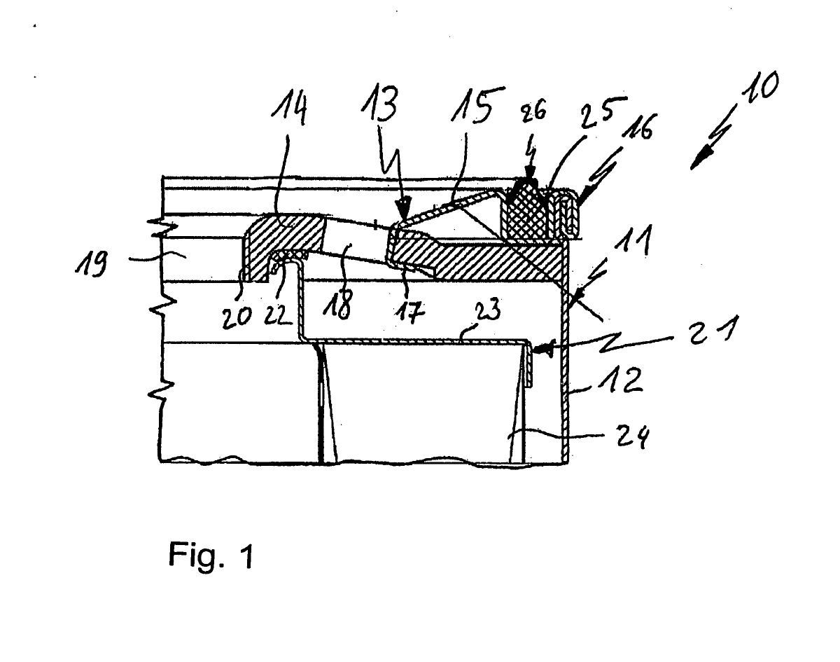

FIG. 1 shows a sectional detail view of an exchangeable filter 10. The exchangeable filter 10 comprises a housing 11 including a vessel 12 and a lid 13. The lid 13 comprises a cover plate 14 and a seal holder 15. The seal holder 15 is connected to the vessel 12 using a crimped connection 16. Furthermore, the seal holder 15 is clamped to the cover plate 14. For this purpose, a tab 17 engages in an inlet opening 18 situated in the cover plate 14. In addition to the inlet opening 18, the cover plate 14 also has a centrally situated outlet opening 19. The outlet opening 19 is enclosed by an attachment thread 20, by which the exchangeable filter 10 may be screwed onto an attachment flange (not shown).

A filter element 21 is situated inside the housing 11, the endplate 23 of the filter element 21 pressing against the cover plate 14 using a flat seal 22 to form a seal. The endplate 23 is connected to a filter medium 24, which is folded in a zigzag shape and is annularly closed, to form a seal.

A seal 25 is situated in the seal holder 15. The seal 25 has a beveled area 26, having a trapezoidal construction, which partially projects beyond the seal holder 15.

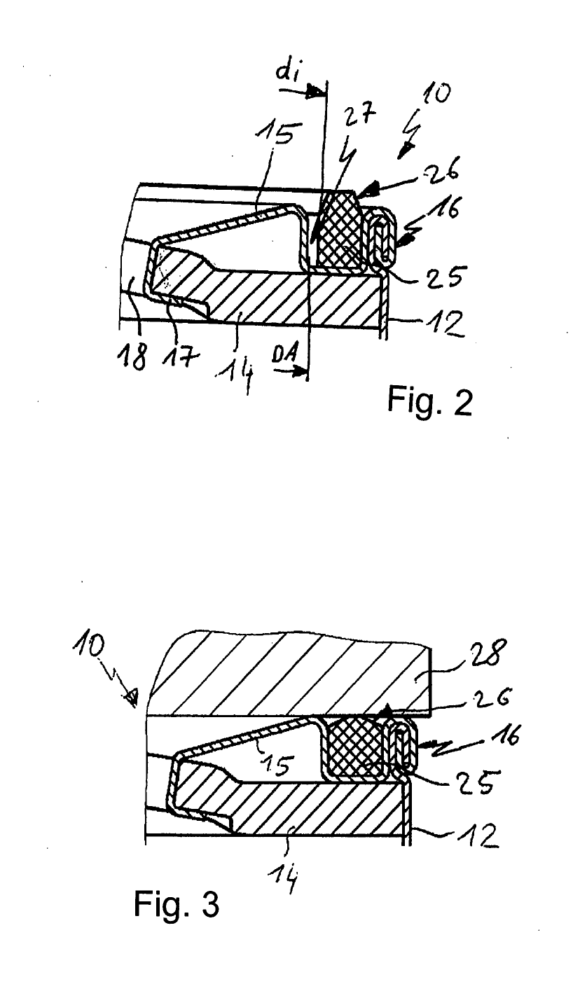

A further design of the seal area is shown in section in FIG. 2. Components corresponding to FIG. 1 are identified by the same reference numerals. The seal 25 has an internal diameter di, which is greater than an internal diameter DA of the groove 27 formed in the seal holder 15 for receiving the seal 25, thereby leaving an intermediate volume. The beveled area 26 projects beyond the groove 27 of the seal holder 15. The cross-section of the seal 25 projecting beyond the groove corresponds to the cross-section of the intermediate volume formed between groove internal diameter DA and seal internal diameter di.

The seal of FIG. 2 is shown in detail in the mounted state in FIG. 3. Again components corresponding to FIGS. 1 and 2 are identified by the same reference numerals. The exchangeable filter 10 is fixed to a flange 28, with the seal 25 being compressed in such a way that the material of the seal 25 fills up the groove 27, and the beveled area 26 contacts the flange 28 to form a seal. The seal holder 15 presses directly against the flange 28, by which the fastening system is made more rigid and relative movements between the exchangeable filter 10 and the flange 28 are prevented. The seal holder 15 acts as a stop by pressing against the flange 28, and thereby prevents over-tightening of the exchangeable filter 10 during mounting.

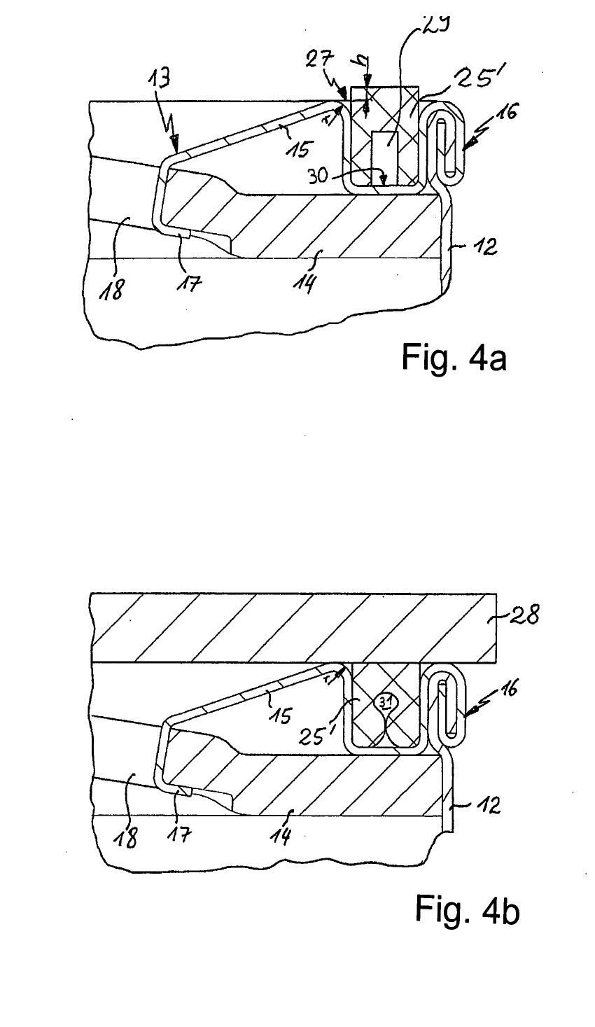

A further embodiment of the seal area is shown in section in FIG. 4a. Once again, components which correspond to the preceding figures are identified by the same reference numerals. The seal 25′ has a rectangular seal cross-section, and a recessed cross-section 29 which is also rectangular and/or U-shaped is provided. The recessed cross-section 29 points toward the base groove 30, as a result of which a displacement volume is formed between the base groove 30 and the seal 25′. The seal 25′ has an area h projecting beyond the groove 27, which has a smaller cross-section than the recessed cross-section 29.

The seal area of FIG. 4a is shown in the mounted state in FIG. 4b. In this mounted illustration, the area h projecting beyond the groove 27 is pressed by the adjoining flange 28 into the groove 27. The areas of the seal 25′ enclosing the recessed cross-section 29 have been compressed and have yielded into the recessed cross-section 29. The adjoining areas press against one another and form a droplet-shaped residual cross-section 31.

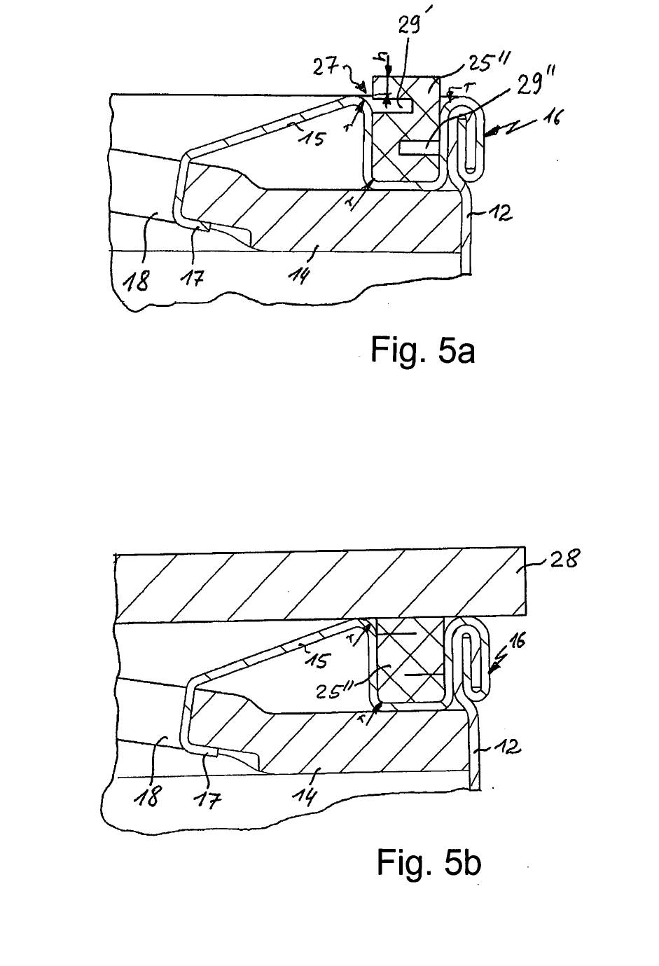

FIG. 5a shows a sectional view of a further design of the seal area. Once again, components which correspond to the preceding figures are identified by the same reference numerals. In this embodiment, the seal 25″ has an S-shaped construction. The recessed cross-section 29 is divided into a left cross-section 29′ and a right cross-section 29″. Because of this design of the seal 25″, all sides of the seal contact the groove 27 and press directly against the groove 27, as a result of which good guidance of the seal 25″ is assured.

The seal area from FIG. 5a is shown in the mounted state in FIG. 5b. The opening cross-sections 29′ and 29″ have been displaced completely by the area h projecting beyond the groove 27 upon mounting, so that in the mounted state no residual cross-section 31 remains as in FIG. 4b, but rather the seal 25″ remains as a rectangular seal block in the groove 27.

In all illustrative embodiments, the groove 27 has transition radii r, which simplifies the production of the groove 27. The cross-section arising due to the radii was not designated as part of the groove cross-section. However, in other embodiments, these transition radii may also be included in the groove cross-section, whereby the seal 25 also can be pressed into these cross-sections.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. An exchangeable filter comprising:
a housing including a vessel, a lid and a seal, the lid having at least one fluid inlet, at least one fluid outlet, and a groove having a groove cross-section for receiving the seal; and
a filter element sealingly situated in the housing such that the at least one inlet is separated from the at least one outlet;
wherein the seal has a seal cross-section which is smaller than or equal to the groove cross-section.

2. An exchangeable filter according to claim 1, wherein the seal has a beveled configuration.

3. An exchangeable filter according to claim 2, wherein the seal has a trapezoidal cross-section.

4. An exchangeable filter according to claim 1, wherein the seal has an internal diameter which is greater than the internal diameter of the groove.

5. An exchangeable filter according to claim 1, wherein the seal has an external diameter which is less than an external diameter of the groove.

6. An exchangeable filter according to claim 1, wherein the seal has a hollow or recessed cross-section.

7. An exchangeable filter according to claim 1, wherein the seal is compressed completely inside the groove when the filter is mounted to a mounting flange.
